(19) United States
(12) Patent Application Publication
(10) Pub. No.: US 2017/0138375 A1
(43) Pub. Date: May 18, 2017

(54) Accumulator Charging Device and System

(71) Applicant: Caterpillar Inc., Peoria, IL (US)

(72) Inventors: Josh A. Grzybowski, Waco, TX (US); Lauritz Pillers, II, McGregor, TX (US)

(73) Assignee: Caterpillar Inc., Peoria, IL (US)

(21) Appl. No.: 14/942,097

(22) Filed: Nov. 16, 2015

(51) Int. Cl. F15B 1/027; F17C 5/06; F15B 1/24

(52) U.S. Cl. CPC F15B 1/027; F15B 1/24; F17C 5/06

(57) ABSTRACT

An adapter for conveying pressurized gas to an accumulator includes a proximal end to receive the canister and establish a fluid communication passage between an interior thereof and an interior of the accumulator. A distal end is configured to engage the accumulator to establish the fluid communication passage. A housing body includes one of the proximal and distal ends and forms a chamber. An adjuster body is adjustably disposed in the housing body. The adjuster body includes the other of the proximal and distal ends and includes adjuster threads configured to engage housing threads to adjust a position of the adjuster body in the housing body. The adjuster body includes an adjustable shut off valve movably disposed in the chamber to close fluid flow through the passageway wherein moving the adjuster into the housing increases pre-load to increase the force necessary to open the shut off valve.

### TECHNICAL FIELD

This disclosure relates generally to machines that employ hydraulic accumulators and, more particularly, to systems and methods relating to charging hydraulic accumulators.

### BACKGROUND

In large industrial machines such as mining and hauling trucks, it is not possible for a human operator to manually generate enough force to effectively brake or steer the machine. Accordingly, most large machines employ hydraulic power brakes and hydraulic power steering systems using hydraulic power to augment the operator's manual force inputs. Thus, these and other, similar, power systems direct a flow of high-pressure hydraulic fluid to the machine's braking or steering actuators to effect braking and steering commands given by the operator.

Such machines may also operate various implements, tools and tool systems with high-pressure hydraulic fluid. While a hydraulic pump may be able to supply the required flow in smaller machines, larger machines require the use of hydraulic accumulators to ensure adequate flow for braking and steering operations while a hydraulically operated implement, such as a hydraulic hammer, is simultaneously used.

In general, a hydraulic accumulator is a device that accepts a certain volume of hydraulic fluid under pressure, which may later selectively release the pressurized hydraulic fluid into the machine hydraulic circuit (or brake or steering hydraulic circuit) or tool when flow is required. In essence, an accumulator stores potential energy in the form of pressurized fluid from the output of the hydraulic pump so that the instantaneous available hydraulic flow is augmented or supplemented when needed.

There are many kinds of hydraulic accumulators, but one type in use today is the gas pre-charged hydraulic accumulator. The gas pre-charged hydraulic accumulator includes a vessel having therein a piston or an equivalent structure. The piston separates the inlet end of the vessel from the enclosed end of the vessel. The enclosed end of the vessel is pre-charged by gas such that the gas can be pressurized when hydraulic fluid under pressure is provided at the inlet, which causes the piston to move and compress the gas.

It is sometimes necessary to charge an accumulator at various times. Typically, charging of an accumulator using current means involves moving a large tank of nitrogen and an adapter to the machinery requiring charging. The adapter is connected to the accumulator. The tank is connected to the adapter via a hose. The accumulator is opened via, for example, manipulation of a hex plug, to permit transfer of pressurized gas from the tank to the accumulator. When the accumulator is filled the tank is shut off. Excess pressure in the accumulator is purged to arrive at the desired gas pressure in the accumulator.

Such current charging systems are heavy and inconvenient to move, which makes the charging process difficult in the field. Such charging systems are expensive and cumbersome, which creates a risk of damaging parts and incurring repair or replacement costs. In addition, current systems require a long and complex charge procedure, which also adds risk, expense, and requires user training.

Accordingly, there are several disadvantages to current systems and methods of charging an accumulator. There is a need for improved systems and methods of charging accumulators.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes an adapter for conveying pressurized gas to an accumulator includes a proximal end to receive the canister and establish a fluid communication passage between an interior thereof and an interior of the accumulator. A distal end is configured to engage the accumulator to establish the fluid communication passage. A housing body includes one of the proximal and distal ends and forms a chamber. An adjuster body is adjustably disposed in the housing body. The adjuster body includes the other of the proximal and distal ends and includes adjuster threads configured to engage housing threads to adjust a position of the adjuster body in the housing body. The adjuster body includes an adjustable shut off valve movably disposed in the chamber to close fluid flow through the passageway wherein moving the adjuster into the housing increases pre-load to increase the force necessary to open the shut off valve.

Another aspect of the disclosure provides a system for charging an accumulator, including a canister with a selected charge of pressurized gas and an adapter for conveying pressurized gas from a canister to an accumulator including a proximal end configured to sealably receive the canister and establish a fluid communication passage between an interior of the canister and an interior of the accumulator. A distal end is configured to engage the accumulator to establish the fluid communication passage. A housing body includes one of the proximal and distal ends and forms a chamber. An adjuster body is adjustably disposed in the housing body. The adjuster body includes the other of the proximal and distal ends and includes adjuster threads configured to engage housing threads to adjust a position of the adjuster body in the housing body. The adjuster body includes an adjustable shut off valve movably disposed in the chamber to close fluid flow through the passageway wherein moving the adjuster into the housing increases pre-load to increase the force necessary to open the shut off valve.

In other aspects, the system and/or adapter may further include an inlet at the proximal end configured to connect the canister to the adapter. The adjuster body may include the inlet. The adapter may further include an adjuster cap that assembles onto the adjuster body at the proximal end and includes the inlet. The adjuster cap may fit within the adjuster body. The inlet may include a pierce configured to breech the canister and the pierce is in communication with the passageway to direct gas from the canister into the passageway. The adjuster threads may be formed outside the adjuster body and the housing threads may be formed inside the housing body. The adapter may further include a housing cap that is configured to assemble onto the housing body. The housing cap may include housing indicia that cooperates with adjuster indicia to indicate the relative axial position of the adjuster body in the housing body.

In yet another aspect, the disclosure provides a method of charging an accumulator with pressurized gas, including providing an adapter for conveying pressurized gas from a canister to an accumulator, including a proximal end configured to sealably receive the canister and establish a fluid communication passage between an interior of the canister and an interior of the accumulator. A distal end is configured to engage the accumulator to establish the fluid communication passage. A housing body includes one of the proximal and distal ends and forms a chamber. An adjuster body is adjustably disposed in the housing body. The adjuster body includes the other of the proximal and distal ends and includes adjuster threads configured to engage housing threads to adjust a position of the adjuster body in the housing body. The adjuster body includes an adjustable shut off valve movably disposed in the chamber to close fluid flow through the passageway wherein moving the adjuster into the housing increases pre-load to increase the force necessary to open the shut off valve. The pre-load of the adjustable shut off valve is set to close after delivery of a selected charge of pressurized gas to the accumulator. The adapter is attached to the accumulator. A canister is attached to the adapter and the adjustable shut off valve is displaced from a closed position to permit pressurized gas to flow from the canister through the adapter into the accumulator. The selected charge of pressurized gas is delivered to the accumulator and the adapter is removed from the accumulator after the adjustable shut off valve closes and the selected charge of pressurized gas has been delivered to the accumulator. The attachment of the canister to the adapter may cause a seal in the canister to be pierced to permit pressurized gas from the canister to flow into the adapter.

Further and alternative aspects and features of the disclosed principles will be appreciated from the following detailed description and the accompanying drawings. As will be appreciated, the principles related to a hydraulic hammer with electrodynamic bearings in disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is an exemplary machine having a hydraulic hammer with an accumulator.

FIG. 2 is a side view of an accumulator charging system in communication with a hydraulic accumulator.

FIG. 3 is a cross section view of an adapter and an accumulator with a gas canister attached to the adapter.

FIG. 4 is a close up cross section view of the adapter of FIG. 2 and an accumulator.

FIG. 5 is a cross section view of the adapter of FIG. 2 in an unadjusted or initial state.

FIG. 6 is a cross section view of the adapter of FIG. 2 in an adjusted state.

FIG. 7 is a cross section view of an accumulator charging system in communication with an accumulator.

FIG. 8 is a cross section view of an accumulator charging system in communication with an accumulator and with a canister in position.

FIG. 9 is a cross section view of an accumulator charging system according to FIG. 7 to demonstrate flow during charging.

FIG. 10 is an exploded perspective view of an adapter according to the disclosure.

FIG. 11 is an exploded side view of the adapter of FIG. 10.

### DETAILED DESCRIPTION

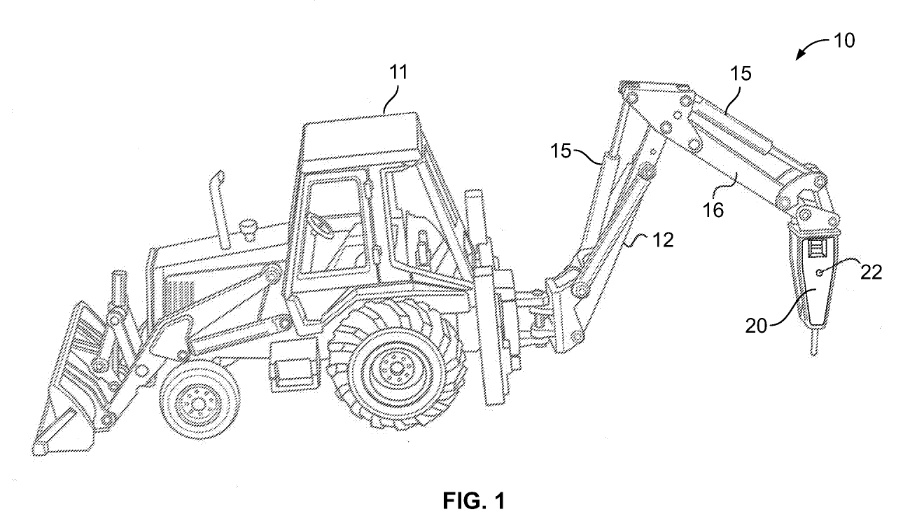

FIG. 1 illustrates an exemplary machine 10 having a hydraulic hammer 20. Machine 10 may be configured to perform work associated with a particular industry such as mining or construction. For example, machine 10 may be a backhoe loader (shown in FIG. 1), an excavator, a skid steer loader, or any other machine. Hydraulic hammer 20 may be pivotally connected to machine 10 through a boom 12 and a stick 16.

In the disclosed embodiment, one or more hydraulic cylinders 15 may raise, lower, and/or swing boom 12 and stick 16 to correspondingly raise, lower, and/or swing hydraulic hammer 20. The hydraulic cylinders 15 may be connected to a hydraulic supply system (not shown) within machine 10 in the known fashion. In the illustrated embodiment, the machine 10 includes a pump (not shown) connected to hydraulic cylinders 15 and to hydraulic hammer 20 through one or more hydraulic supply lines (not shown for simplicity). The hydraulic supply system may introduce pressurized fluid, for example oil, from the pump into the hydraulic cylinders 15 and also into an actuator operating the hammer 20. Operator controls for movement of hydraulic cylinders 15 and/or hammer 20 may be located within a cabin 11 of machine 10.

As shown in FIG. 1, hydraulic hammer 20 includes an accumulator gas inlet 22 or port for charging an accumulator that is disposed within or is otherwise associated with the hydraulic hammer 20. It will be understood that other aspects of the machine 10 may have accumulators for steering and braking, and/or for other systems of the machine in the typical fashion. The present disclosure contemplates an accumulator charging system for any of the accumulators in a machine.

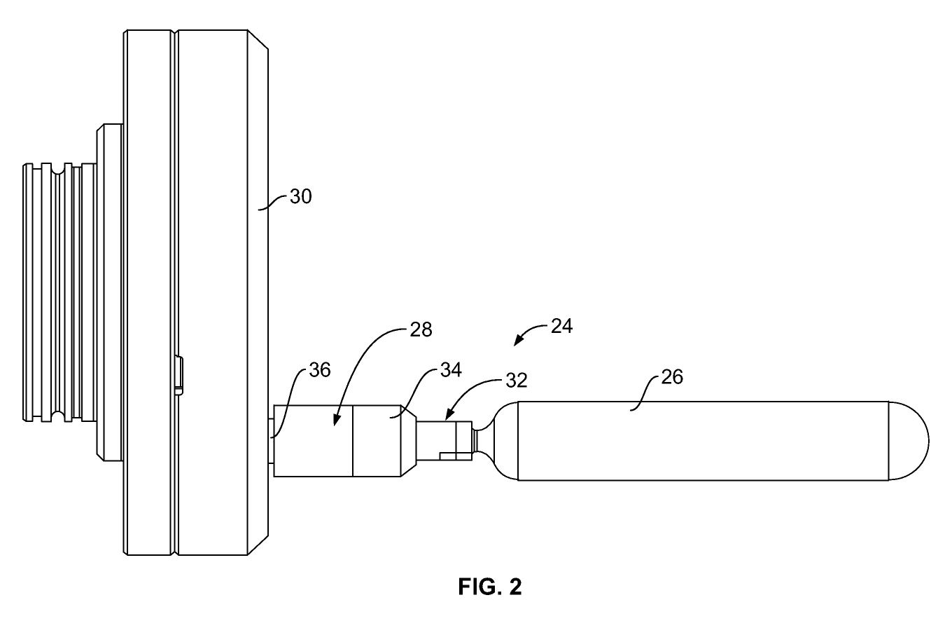

The exemplary embodiments described herein are directed to an accumulator charging system 24 and method of charging an accumulator 30. An illustration of the accumulator 30, which may be used in the machine 10, is shown in FIG. 2. Generally, the accumulator charging system 24 includes two main parts: a gas canister 26, and a charge adapter 28.

The gas canister 26 is embodied as a sealed cartridge containing a predetermined or specified amount of a gas such as nitrogen for charging the accumulator 30. The gas canister 26 may be any suitable form such as a cylindrical bottle and is formed of a material capable of containing the gas at a high pressure, such as metal. The volume of the gas canister 26 and pressure of gas inside the canister is dependent on the amount of gas to be added to an accumulator 30 in a single charge event. In other words, the gas canister 26 is designed and constructed to be a single use source of gas. Because the gas canister 26 is single use only, it can be scaled to contain a single predetermined charge of gas designed for a specific accumulator 30. Accordingly, the size of the gas canister 26 may be sized such that it can be held in the hand and/or easily carried. The volume of the gas canister 26 and the pressure of the gas held within can be determined in the known fashion, for example, by applying Boyle's law, based on the volume of the accumulator 30, the specified gas pressure to be delivered to the accumulator, and the expected temperature. The specified or predetermined volume and pressure of gas within the gas canister 26 may be referred to as a charge.

The charge adapter 28 is interposed and provided with elements for connection to the gas canister 26 and the device to be charged, i.e., the accumulator 30, to facilitate the transfer of gas from the canister to the accumulator when a charging operation is performed for the accumulator. In general, the adapter 28 has a proximal end 32 that receives the canister 26 and includes elements to establish fluid communication with the canister and sealingly retain the canister in position for charging. A mid-portion or body 34 of the adapter 28 includes elements that provide passage of gas through the adapter and an adjustable shut-off setting for delivering the charge. A distal end 36 of the adapter 28 includes elements for attaching the adapter to the accumulator 30 or a port for establishing a fluid communication with the accumulator.

The accumulator 30 can be any known accumulator that operates with a pressurized gas charge. While the accumulator illustrated is intended for use with a hydraulic hammer, it will be understood that the system and methods described herein are usable with or can be adapted to interface with any particular accumulator configuration.

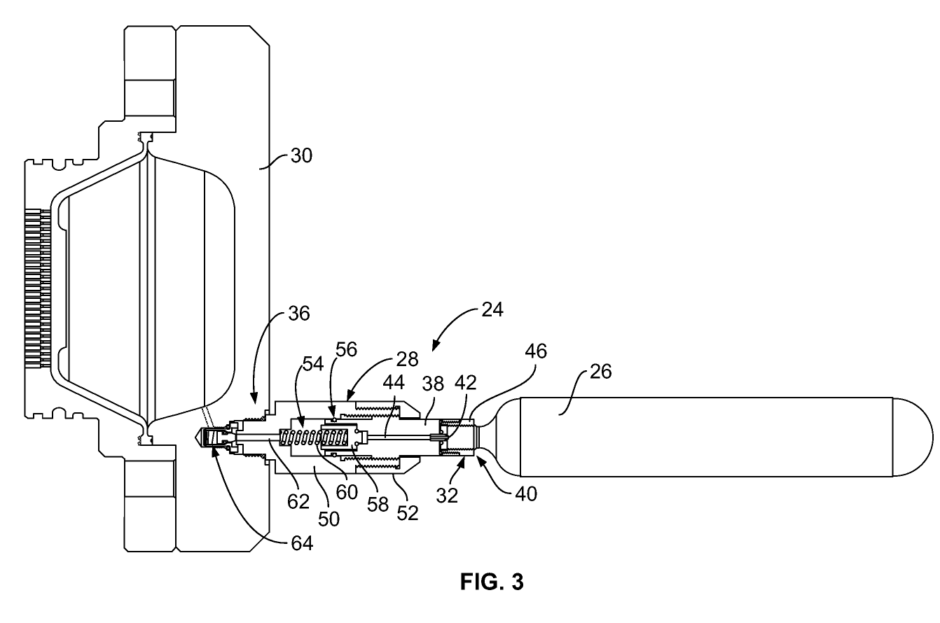

FIG. 3 illustrates structures of the adapter 28 and accumulator 30 according to an embodiment of the disclosure. The proximal end 32 of the adapter 28 includes an adjuster body 38, which may be generally cylindrical. The adjuster body 38 includes an inlet 40 that is sized and shaped to receive, and retain, the gas canister 26. The inlet 40 may be included as part of the adjuster body 38 or, in an alternative embodiment, may be embodied as a separate, internally threaded adjuster cap 46. The inlet 40 operates to engage the canister 26. The adjuster cap 46 is a hollow cylindrical component that engagingly receives the gas canister 26, attaches to the canister 26, and also attaches to the adjuster body 38.

The inlet 40 includes a hollow pierce 42 that breaches a wall or seal of the gas canister 26 upon insertion of the canister into the inlet to permit fluid flow of gas from the canister. As the canister 26 is advanced into the inlet 40, the pierce 42 forms a hole through a closed or sealed end of the canister 26 to permit pressurized gas to flow from the canister.

The adjuster body 38 includes an adjuster body passageway 44 for conveying gas from the hollow pierce 42 disposed at the inlet 40 through the adjuster body. The adjuster body passageway 44 may be an axial bore formed through the adjuster body that is open to the inlet 40. The adjuster body passageway 44 receives, and is in fluid communication with, the hollow pierce 42.

The adjuster body 38 is axially adjustably received within a housing body 50. The housing body 50 includes a fluid chamber 54 defined, in part, by the adjuster body 38 and the housing body 50. The housing body 50 may be provided with a housing cap 52. The housing cap 52 is disposed at the proximal end 32 of the housing.

The fluid chamber 54 includes an adjustable shut off valve 56. The adjustable shut off valve 56 includes a valve body 58 that is sealingly biased against the adjuster body 38 to fluidly open and fluidly block the adjuster body passageway 44. The valve body 58 is biased by a biasing member 60 that may be disposed within the fluid chamber 54.

The proximal end 32 of the adapter 28 includes an outlet port 62 in communication with the fluid chamber 54 for conveying gas from the fluid chamber to the accumulator 30 through the adapter. The accumulator 30 includes a check valve 64 biased in a closed condition that functions to permit gas to enter the accumulator when open and prevent the escape of gas when closed.

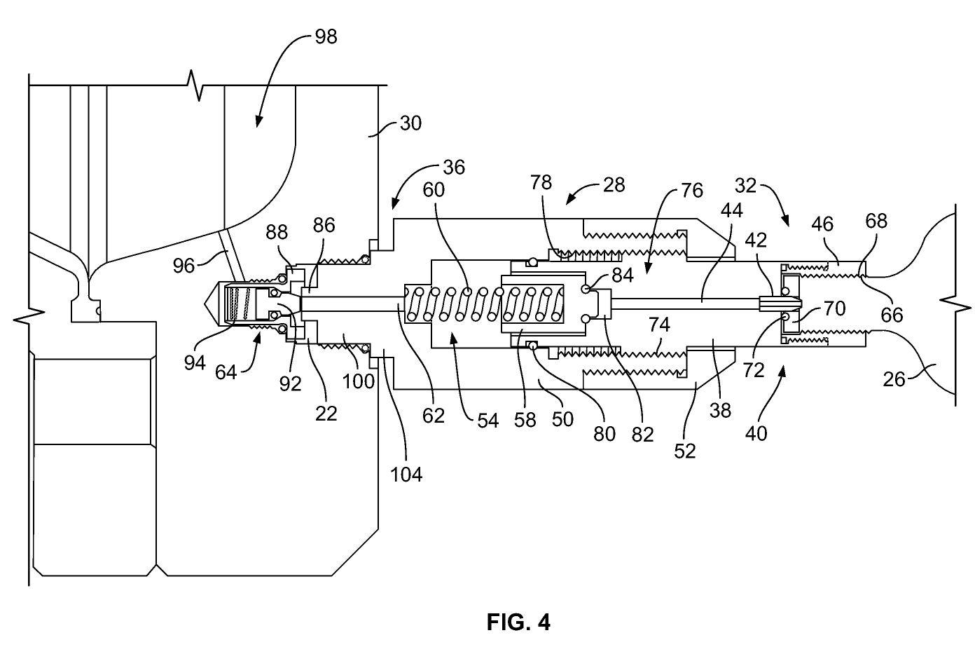

FIGS. 4, 7, 8 and 9 show adapter 28 engaged, at its distal end 36, with accumulator 30, and also engaged at its proximal end 32 with canister 26. Canister 26 is threadably attached to the adapter 28 via engagement of canister exterior threads 66 with housing cap 52 interior threads 68. Inlet end 40 includes annular seal 70 surrounding the pierce 42 positioned to seal against the canister 26. The inlet end 40 may also include an inlet o-ring seal 72 to seal the annular seal 70 to the pierce 42 and adjuster body 38.

The adapter 28 adjuster body 38 is internally received by housing body 50. Adjuster body 38 may be generally cylindrical and may include exterior adjuster threads 74 on a mid-section 76 thereof. The mid-section may have a diameter greater than the ends of the adjuster body. The exterior adjuster threads 74 engage internal housing threads 78 such that the axial position of the adjuster 38 can be adjusted relative to the housing 50 through rotation thereof, thereby changing the pre-load exerted by valve biasing member 60.

The adjuster body 38 may include an adjuster o-ring type seal 80 at an end adjacent the fluid chamber 54. The adjuster body 38 includes a valve bore 82 at the end open to the fluid chamber 54. The valve body 58 is disposed within the valve bore 82 and arranged to move axially within the valve bore. The valve body 58 is provided with a valve body seal 84, which may be in the form of an o-ring. The valve bore 82 is in fluid communication with the adjuster body passageway 44.

The outlet port 62 is in fluid communication with the fluid chamber 54 and is open to the outside of the housing body 50 at the distal end 36 of the adapter 28. The distal end 36 may include three different diameter cylindrical portions, each protruding axially a progressively greater distance from a respective adjacent portion from the main part of the housing 50.

The first cylindrical portion 86 is the most distal, has the smallest diameter, and includes the outlet port 62. The first cylindrical portion 86 is sized and shaped to fit within a check valve body 88 of check valve 64.

The check valve 64 resides within the accumulator inlet 22, formed in the accumulator 30. The check valve 64 includes a check valve piston 92 that seals against the check valve body 88 in a closed position and a check valve biasing member 60 disposed within the check valve body 88 that urges the check valve piston 92 into sealing engagement with the check valve body. The check valve 64, when open, permits gas to flow from the adapter 28 into the accumulator 30. The accumulator 30 may include an accumulator passage 96 that directs gas from the check valve 64 to an interior 98 of the accumulator. When the first cylindrical portion 86 is inserted into the accumulator inlet 22, the check valve piston 92 is caused to disengage from its sealing engagement with the check valve body 88, and gas may move from the outlet port 62, past the opened check valve 64, and through the accumulator passage 96 before entering the interior 98.

The distal end 36 may have a second cylindrical portion 100, with a diameter greater than the first cylindrical portion 86. The second cylindrical portion 100 may include an o-ring seal 106. The second cylindrical portion 100 may be threaded 102 to threadably engage with cooperating features formed in the accumulator inlet 22 to hold the adapter 28 in place during charging.

The distal end 36 of the adapter 28 may also include a third cylindrical portion 104 that forms a shoulder to act as a stop against the accumulator 30. The third cylindrical portion 104 has a greater outer diameter than the second cylindrical portion 100. A distal end seal 106, which may be in the form of an o-ring, may be provided to the adapter 28 positioned at the junction of the second and third portion 100, 104 to seal against the accumulator 30 when the adapter is fully inserted into the accumulator inlet 22.

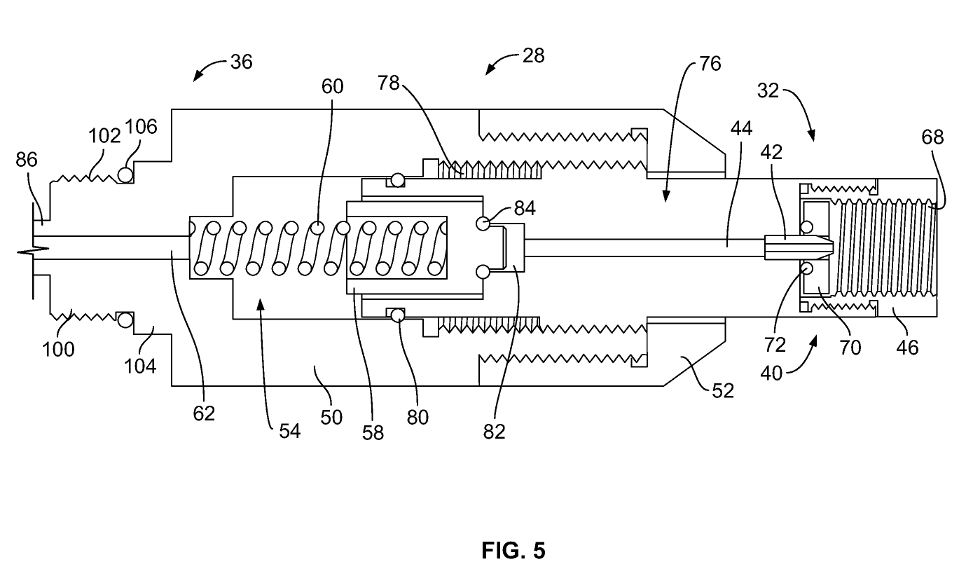

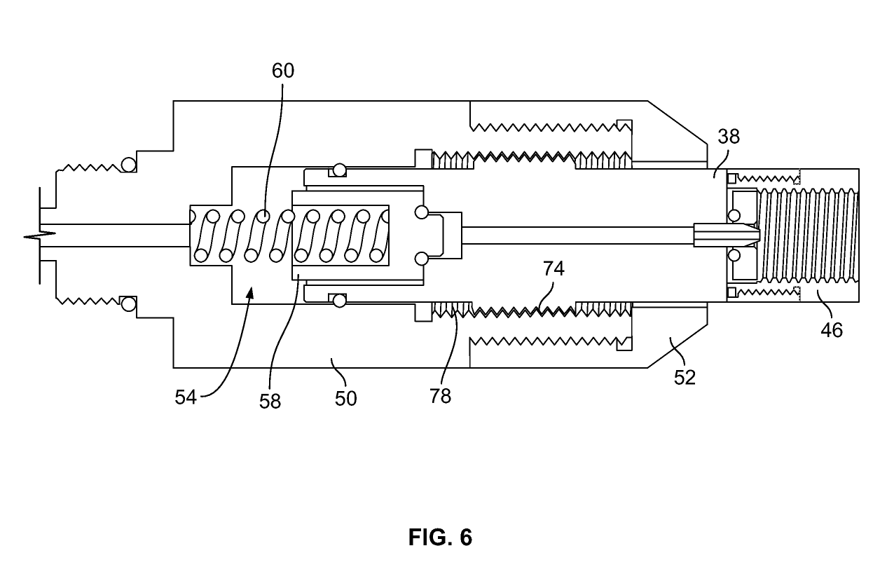

In operation, the adapter 28 as illustrated in FIGS. 5 and 6 may be used such that the adjuster body 38 is placed in an initial, unadjusted condition or configuration (FIG. 5) and then into an adjusted condition or configuration (FIG. 6). The axial position of the adjuster body 38 in the housing body 50 can be changed to create adjustments of the pre-load on the adjustable shut off valve 56. Accordingly, the shut-off characteristics of the adjustable shut off valve 56 can be predictably selected to deliver a known charge of gas from a known, fixed canister pressure and volume.

When the adjuster body 38 is backed out of the housing body 50, as shown in FIG. 5, the valve biasing member 60 is extended to a maximum amount where it exerts a minimum force on the valve body 58. In this condition, the adjustable check valve 64 opens easily and stays open longer to deliver a relatively larger charge from a fixed canister pressure and volume. When the adjuster body 38 is adjusted inwardly into the housing body 50, as shown in FIG. 6, the valve biasing member 60 is compressed to exert a maximum force on the valve body 58. In this condition, the adjustable check valve 64 opens at a larger pressure difference and closes relatively early to deliver a relatively smaller charge from a fixed canister pressure and volume. The adjuster body 38 is selectively adjustable anywhere between the minimum and maximum settings such that a charge is delivered based on the position of the adjuster body 38 in the housing body 50 and the relative compression of the valve biasing member 60.

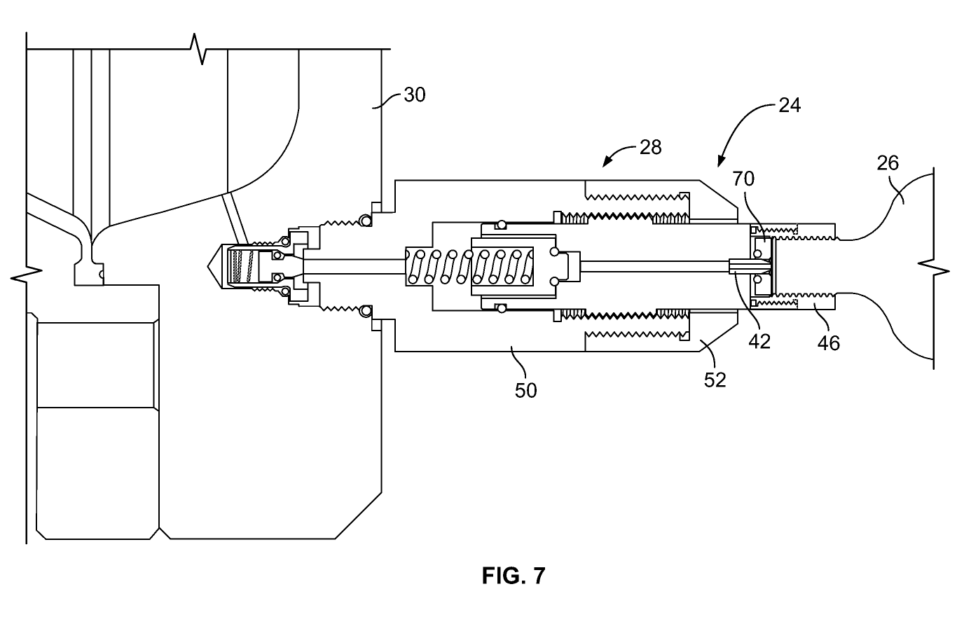

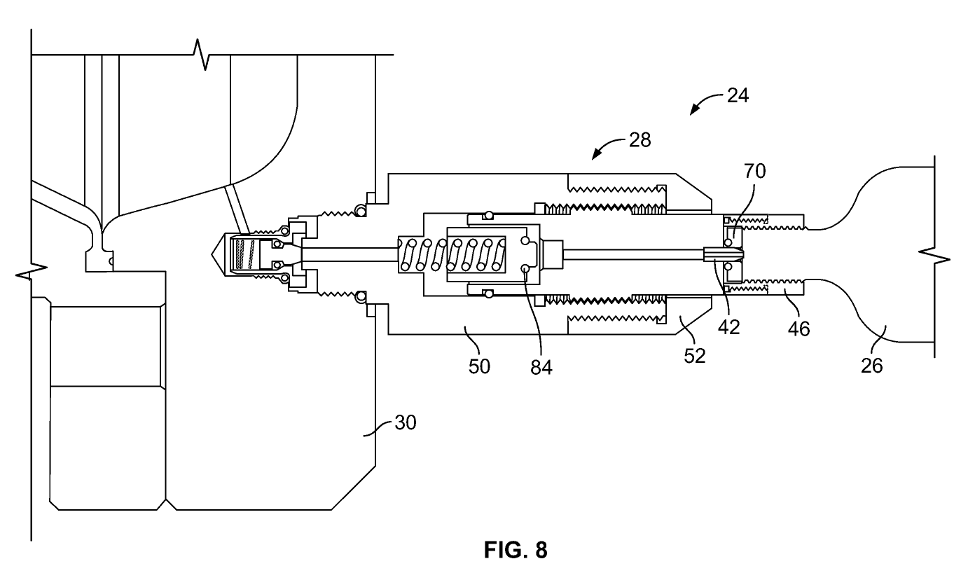

FIG. 7 shows the canister 26 engaged with adjuster cap 46 but before the canister is pierced by pierce 42 and sealed against annular seal 70. FIG. 8 shows the canister 26 engaged with adjuster cap 46 and fully inserted such that the canister is pierced by pierce 42 and sealed against annular seal 70.

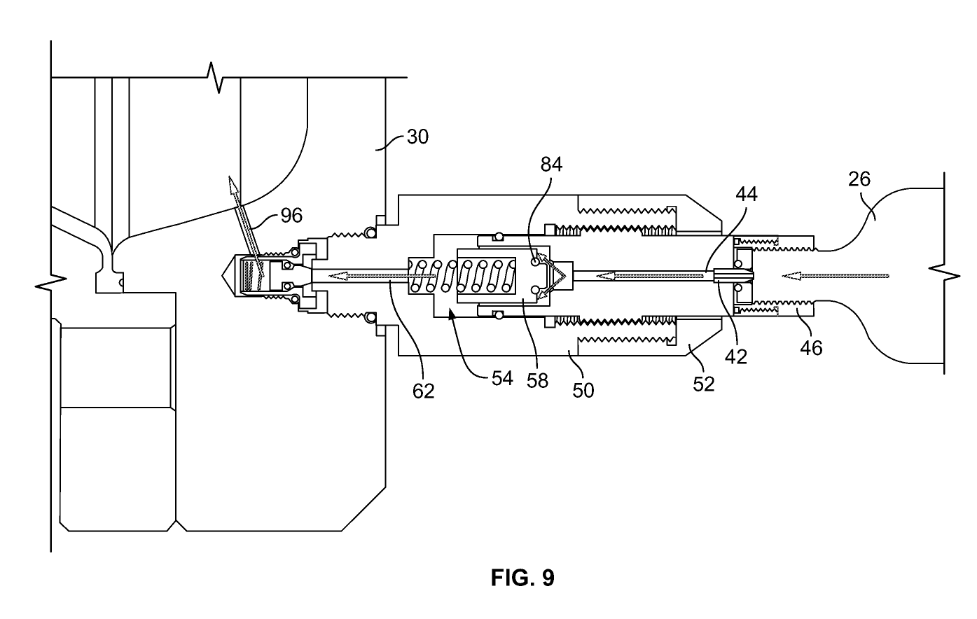

FIG. 9 shows the configuration of FIG. 8 and the flow of gas from the canister 26, through pierce 42 and adjuster body passageway 44, past open valve body 58 and into chamber 54. Gas exits chamber 54 through outlet port 62 of housing body 50 and flows into the accumulator 30 via accumulator passage 96.

When a specified amount of gas from canister 26 passes through the adapter 28 and into accumulator 30, a force on the valve body 58 exerted by biasing member 60 becomes greater than the force generated by the pressure of gas remaining in the canister on the valve body. When the pressure has sufficiently increased, the valve body 58 closes by the valve biasing member 60 to seal the passageway 44 and permit removal of the adapter 28 from the accumulator 30. The canister 26 can be disposed or recycled and the adapter 28 can be reused to charge another accumulator.

Referring to the figures, a method of charging an accumulator 30 includes attaching the adapter 28 to the accumulator 30. The attachment includes inserting the distal end 36 into the inlet 22 and causing the first cylindrical portion 86 to push the check valve piston 92 away from its seat on the check valve body 88. The second cylindrical portion 100 threads into the inlet 22. The third cylindrical portion 104 seals against the accumulator 30. In this way, the method includes establishing fluid communication between the adapter 28 and accumulator 30. The canister 26 is inserted into the inlet 40 of the adjuster body 38 until the pierce 42 breaches the canister and the canister is fully sealed to the annular seal 70. Gas flows from the canister 26 through the adjuster body passageway 44 displacing the adjustable shut off valve 56 from a sealed position to an open position. Gas flows through the chamber 54 and through outlet port 62 into the accumulator 30 until the pressure of gas in the canister falls to a level that permits the adjustable shut off valve 56 to close. At that point, the adapter 28 may be removed from the accumulator 30 and the check valve piston 92 closes to retain the gas charge within the accumulator.

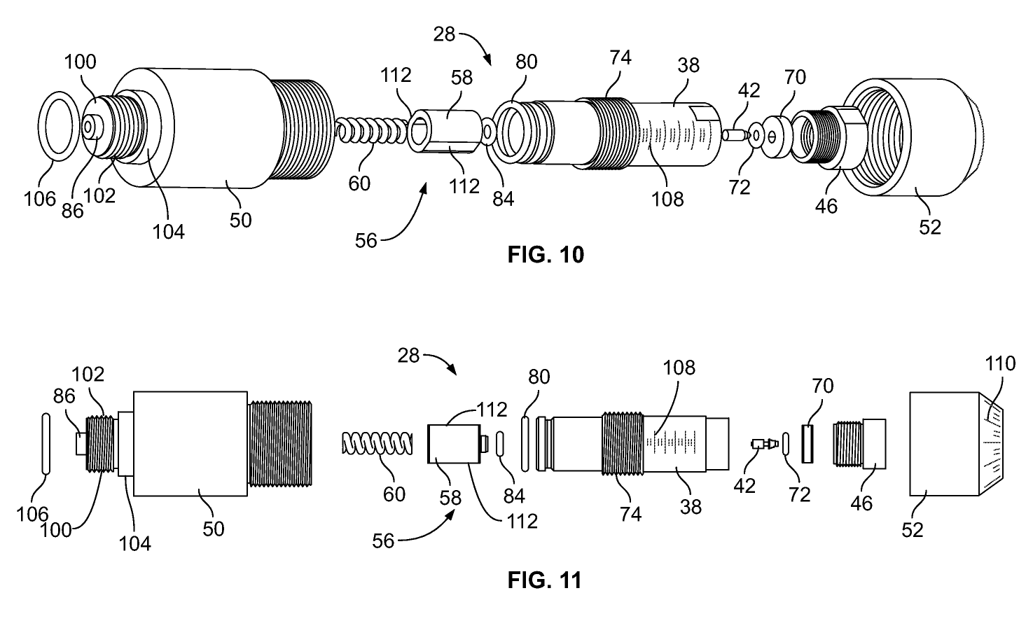

FIGS. 10 and 11 are exploded views of the adapter 28. The charge adapter 28 includes a housing cap 52 that threads onto the housing body 50 via threads. An adjuster body 38 is adjustably disposed in the housing body 50 via threads 74. The adjuster body 38 includes adjustable shut off valve 56. The adjustable shut off valve 56 includes valve body 58 with an associated seal 84 disposed thereon. The valve body 58 is movably disposed within the adjuster body 38 and biased into a closed position by valve biasing member 60. The valve body 58 includes flats 112, which permits passage of fluid around the valve body when the adjustable shut off valve 56 is in an open condition.

The housing cap 52 may include indicia 110 that can be used together with indicia 108 on the adjuster body 38 to indicate the relative position of the adjuster body 38 in the housing body 50 and provides a gauge of the pre-load setting of the adjustable shut off valve 56. The indicia 108 on the adjuster body 38 may index to end of the housing cap 52 to indicate the position of the adjuster body. In one embodiment, the indicia 110 on the housing cap 52 is optional.

The adjuster body 38 also may include adjuster cap 46, which includes pierce 42 with an associated annular seal 70 and inlet o-ring 72. The housing body 50 may include first, second and third cylindrical portions 86, 100, and 104. The second cylindrical portion 100 may include threads for connection to an accumulator (not shown). The housing body 50 may include an o-ring seal 106 disposed on the second cylindrical portion 100 for sealing the adapter 28 to an accumulator.

### INDUSTRIAL APPLICABILITY

The adapter and accumulator charging system according to the disclosure provides a safe, reliable, inexpensive and simple system for accurately charging an accumulator. Specifically, the disclosed system eliminates cumbersome gas bottles and hoses and does not require adjustment of the accumulator gas pressure after charging.

Although the disclosed embodiments have been described with reference to a machine with a hydraulic hammer, the disclosed embodiments are applicable to any machine having a hydraulic accumulator or gas charged mechanism.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An adapter for conveying pressurized gas from a canister to an accumulator, comprising:
a proximal end configured to sealably receive the canister and establish a fluid communication passage between an interior of the canister and an interior of the accumulator;
a distal end remote from the proximal end, wherein the distal end is configured to sealably engage the accumulator to establish the fluid communication passage;
a housing body including one of the proximal and distal ends and forming a chamber;
an adjuster body adjustably disposed in the housing body, the adjuster body including the other of the proximal and distal ends and adjuster threads configured to engage housing threads to cooperatively adjust a position of the adjuster body in the housing body, the adjuster body having a passageway formed axially therethrough in communication with the chamber; and
an adjustable shut off valve movably disposed in the chamber, the adjustable shut off valve including a valve body and a biasing member that biases the valve body into sealing engagement with the adjuster body to close fluid flow through the passageway;
wherein moving the adjuster body into the housing body increases the pre-load of the biasing member to increase the force necessary to open the adjustable shut off valve.

2. The adapter of claim 1, further comprising an inlet at the proximal end configured to connect the canister to the adapter.

3. The adapter of claim 2, wherein the adjuster body includes the inlet.

4. The adapter of claim 3, further comprising an adjuster cap that assembles onto the adjuster body at the proximal end and includes the inlet.

5. The adapter of claim 4, wherein the adjuster cap fits within the adjuster body.

6. The adapter of claim 3, wherein the inlet includes a pierce configured to breech the canister and the pierce is in communication with the passageway to direct gas from the canister into the passageway.

7. The adapter of claim 1, wherein the adjuster threads are formed outside the adjuster body and the housing threads are formed inside the housing body.

8. The adapter of claim 1, further comprising a housing cap that is configured to assemble onto the housing body.

9. The adapter of claim 8, wherein the housing cap includes housing indicia that cooperates with adjuster indicia to indicate the relative axial position of the adjuster body in the housing body.

10. A system for charging an accumulator, comprising:
a canister including a selected charge of pressurized gas; and
an adapter for conveying pressurized gas from a canister to an accumulator, comprising:
a proximal end configured to sealably receive the canister and establish a fluid communication passage between an interior of the canister and an interior of the accumulator;
a distal end remote from the proximal end, wherein the distal end is configured to sealably engage the accumulator to establish the fluid communication passage;
a housing body including one of the proximal and distal ends and forming a chamber;
an adjuster body adjustably disposed in the housing body, the adjuster body including the other of the proximal and distal ends and adjuster threads configured to engage housing threads to cooperatively adjust a position of the adjuster body in the housing body, the adjuster body having a passageway formed axially therethrough in communication with the chamber; and
an adjustable shut off valve movably disposed in the chamber, the adjustable shut off valve including a valve body and a biasing member that biases the valve body into sealing engagement with the adjuster body to close fluid flow through the passageway;
wherein moving the adjuster body into the housing body increases the pre-load of the biasing member to increase the force necessary to open the adjustable shut off valve.

11. The system of claim 10, further comprising an inlet at the proximal end configured to connect the canister to the adapter.

12. The system of claim 11, wherein the adjuster body includes the inlet.

13. The system of claim 12, further comprising an adjuster cap that assembles onto the adjuster body at the proximal end and includes the inlet.

14. The system of claim 13, wherein the adjuster cap fits within the adjuster body.

15. The system of claim 12, wherein the inlet includes a pierce configured to breech the canister and the pierce is in communication with the passageway to direct gas from the canister into the passageway.

16. The system of claim 10, wherein the adjuster threads are formed outside the adjuster body and the housing threads are formed inside the housing body.

17. The system of claim 10, further comprising a housing cap that is configured to assemble onto the housing body.

18. The system of claim 17, wherein the housing cap includes housing indicia that cooperates with adjuster indicia to indicate the relative axial position of the adjuster body in the housing body.

19. A method of charging an accumulator with pressurized gas, comprising:
providing an adapter for conveying pressurized gas from a canister to an accumulator, including a proximal end configured to sealably receive the canister and establish a fluid communication passage between an interior of the canister and an interior of the accumulator;
a distal end remote from the proximal end, wherein the distal end is configured to sealably engage the accumulator to establish the fluid communication passage; a housing body including one of the proximal and distal ends and forming a chamber; an adjuster body adjustably disposed in the housing body, the adjuster body including the other of the proximal and distal ends and adjuster threads configured to engage housing threads to cooperatively adjust a position of the adjuster body in the housing body, the adjuster body having a passageway formed axially therethrough in communication with the chamber; and
an adjustable shut off valve movably disposed in the chamber, the adjustable shut off valve including a valve body and a biasing member that biases the valve body into sealing engagement with the adjuster body to close fluid flow through the passageway; wherein moving the adjuster body into the housing body increases the pre-load of the biasing member to increase the force necessary to open the adjustable shut off valve;
setting the pre-load of the adjustable shut off valve to close after delivery of a selected charge of pressurized gas to the accumulator;
attaching the adapter to the accumulator;
attaching a canister to the adapter and causing the adjustable shut off valve to be displaced from a closed position to permit pressurized gas to flow from the canister through the adapter into the accumulator;
delivering the selected charge of pressurized gas to the accumulator; and
removing the adapter from the accumulator after the adjustable shut off valve closes and the selected charge of pressurized gas has been delivered to the accumulator.

20. The method of claim 19, wherein said attaching of the canister to the adapter pierces a seal in the canister to permit pressurized gas from the canister to flow into the adapter.
